(19) United States
(12) Patent Application Publication
(10) Pub. No.: US 2009/0085514 A1
(43) Pub. Date: Apr. 2, 2009

(54) BATTERY CHARGER

(75) Inventors: Toshio Mizoguchi, Ibaraki (JP); Haruhisa Fujisawa, Ibaraki (JP); Keita Saitou, Ibaraki (JP)

Correspondence Address: MATTINGLY, STANGER, MALUR & BRUNDIDGE, P.C., 1800 DIAGONAL ROAD, SUITE 370, ALEXANDRIA, VA, 22314, US

(73) Assignee: Hitachi Koki Co., Ltd.

(21) Appl. No.: 12/233,846

(22) Filed: Sep. 19, 2008

(30) Foreign Application Priority Data
Sep. 25, 2007 (JP) 2007-248250

(51) Int. Cl. H02J 7/00

(52) U.S. Cl. 320/113

(57) ABSTRACT

The problem of the present invention is to configure a battery charger such that water intruded into a gap between a plugging portion of a battery connection part in the battery charger and a battery pack does not contact the circuit substrate, with a simple and low-cost configuration, and improving recyclability of the circuit substrate. The battery charger is configured such that water intruded from the gap between the plugging portion of the battery connection portion and the battery pack, is guided through a through-hole of a protruded portion provided at the bottom of the plugging portion to the lower side of the circuit substrate provided on the bottom case.

### BACKGROUND OF THE INVENTION

1. Field of the Invention

The present invention relates to a battery charger to charge a battery pack.

2. Description of the Related Art

Configuration of a conventional battery charger is described using FIGS. 4 to 6. Battery charger 100 is configured by placing a circuit substrate 5, a charging terminal 6 and a signal terminal 6C in a body case 2 composed of a top case 3 and a bottom case 4. The top case 3 is provided with a battery connection portion 8 for connecting to a battery pack 7. The battery connection portion 8 is provided with a plugging portion (retention portion) 8A in order to retain the battery pack 7 when the battery pack 7 is inserted, and terminal insertion holes 10, through which the charging terminal 6 and the signal terminal 6C pass, are provided at the bottom of the plugging portion 8A. A charge and discharge terminal 9 of the battery pack 7 contacts the charging terminal 6 to charge the battery pack 7. On the other hand, the circuit substrate 5, on which electronic components comprising a charging circuit are mounted, is accommodated in the bottom case 4, and the charging terminal 6 is electrically connected to the charging circuit. A drain outlet (vent) 11 to drain water intruded into the inside of the battery charger 100 is provided at the bottom side of the bottom case 4.

Incidentally, as the battery charger 100 may be used outdoors, there are cases in which it may get wet with rain water. Regarding the case when rain water and the like are intruded into the battery charger 100, it will be described using FIGS. 5 and 6. As shown in FIG. 5, when the battery pack 7 is not connected to the battery charger 100, the plugging portion 8A is open to the outside, thereby resulting in intrusion of rain water into the plugging portion 8A. Since the terminal insertion holes 10 are arranged at the bottom of the plugging portion 8A, rain water intruded into the plugging portion 8A enters from the terminal insertion holes 10 into the body case 2 (inside of the battery charger 100) to run down on the circuit substrate 5. Rain water thereafter runs down through a gap between the circuit substrate 5 and the bottom case 4, runs down onto the bottom of the bottom case 4, and drains from the drain outlet 11 provided on the bottom side of the bottom case 4 to the outside of the battery charger 100.

On the other hand, when the battery pack 7 is connected to the battery charger 100, the plugging portion 8A is blocked by the battery pack 7 in a situation, in which the battery pack 7 is inserted into the plugging portion 8A of the battery charger 100 as shown in FIG. 6. However, since there is a gap 12 between the plugging portion 8A and the battery pack 7, rain water intrudes through this gap 12 into the plugging portion 8A. Intruded rain water runs down in the direction indicated by an arrow in the drawings, running down from the terminal insertion holes 10, provided on the bottom of the plugging portion 8A onto the circuit substrate 5. Rain water thereafter drains out similarly as described above from the drain outlet 11 provided on the bottom case 4 to the outside of the battery charger 100. A drain structure for the battery charge has also been disclosed in Japanese Utility Model Application KOKAI Publication No. H06-68303.

When water rain is intruded into the battery charger 100 as above, the circuit substrate 5 gets wet with water. This causes poor charging of a battery due to short-circuiting in the charging circuit, or generates a malfunction such as overcharging and the like by not terminating charging even if the battery pack 7 is fully charged, or electrically corrodes electronic components comprising the charging circuit, causing failure of the battery charger 100. Therefore, measures for preventing water immersion in the battery charger 100 has been implemented with configuration, in which the circuit substrate 5 is not arranged in an intrusion portion in the apparatus in order to prevent the charging circuit from failure even if water intrudes into the apparatus. An opening such as ventilating windows and the like is not arranged on the top case 3 and the bottom case 4 as much as possible in order to prevent the charging circuit from failure even if water intrudes into the circuit substrate 5 and furthermore a waterproof agent such as silicones and the like are applied to electronic components prone to water damage as a measures for preventing water immersion.

However, as a configuration not providing an opening such as ventilating windows and the like still leaves the gap 12 between the battery charger 100 and the battery pack 7, water intruding through the gap 12 and the terminal insertion holes 10, into the battery charger 100 cannot be prevented. Therefore, the circuit substrate 5 is made waterproof by applying silicone to a wide area centered on the lower side of the terminal insertion holes 10. However, there have been problems with high cost in silicone coating, as well as poor recyclability since silicone has to be removed when disassembling the circuit substrate 5. While it has also been devised not to mount water damage prone electronic components on the lower side of the terminal insertion holes 10, constraint with implementation of the circuit substrate 5 has prevented ideal designing, generating a barrier for miniaturizing the circuit substrate 5 and furthermore the battery charger 100.

### SUMMARY OF THE INVENTION

The present invention has been carried out in relation to actual conditions described above and has an object to waterproof the circuit substrate with inexpensive composition as well as improve recyclability of the circuit substrate.

In order to achieve the object described above, a battery charger related to the present invention is

a battery charger to charge a battery pack comprising;
a circuit substrate having a circuit provided with a charging terminal for connecting to the battery pack and having an insertion hole formed thereon, and
a body case having a battery connection portion for connecting to a terminal of the battery pack and a drain outlet configured to drain water intruded into inside of the body case, the body case accommodating the circuit substrate in a space between the battery connection portion and the drain outlet, having a protruded portion protruding to pass through the insertion hole from the battery connection portion, and having a guide portion formed on the protruded portion and communicated with the battery connection portion extending towards the protruding direction of the protruded portion.

According to the present invention, rain water flows via the insertion hole of the circuit substrate along the guide portion, thereby preventing the circuit board from getting wet by rain water.

### BRIEF DESCRIPTION OF THE DRAWINGS

FIG. 1 is a top view of a battery charger illustrating an embodiment related to the present invention.

FIG. 2 is a cross-sectional view of the battery charger illustrated in FIG. 1 in the embodiment related to the present invention.

FIG. 3 is a cross-sectional view of the battery pack connected to the battery charger in FIG. 2 related to the present invention.

FIG. 4 is a top view of a battery charger related to prior art in an embodiment illustrated.

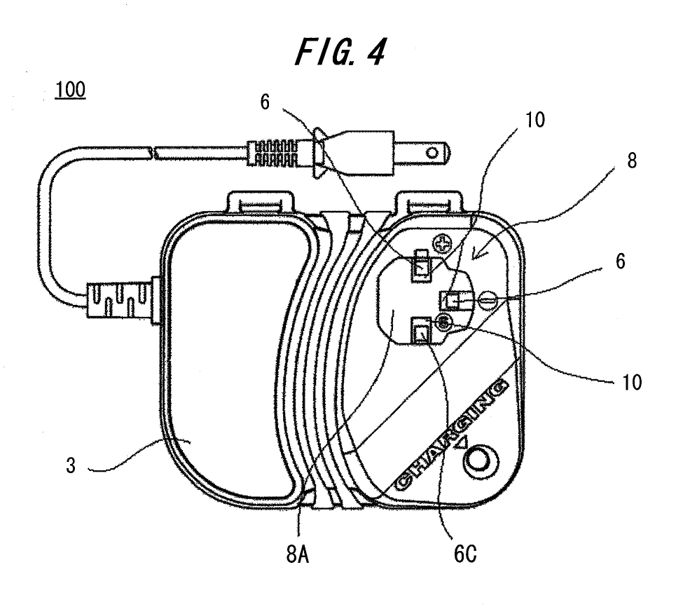

FIG. 5 is a cross-sectional view of the battery charger related to prior art in one embodiment illustrated in FIG. 4.

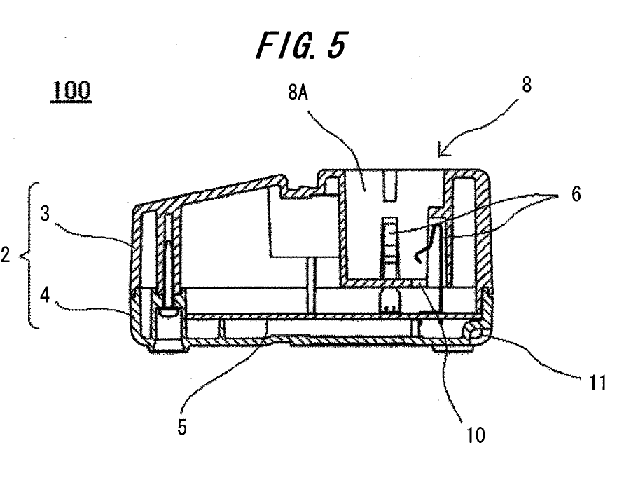

FIG. 6 is a cross-sectional view of the battery pack connected to a battery charger related to a prior art in FIG. 5.

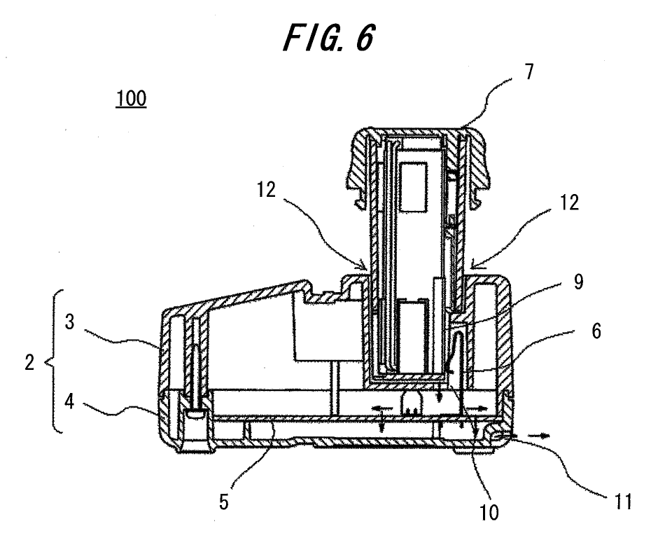

### DETAILED DESCRIPTION OF THE PREFERRED EMBODIMENT

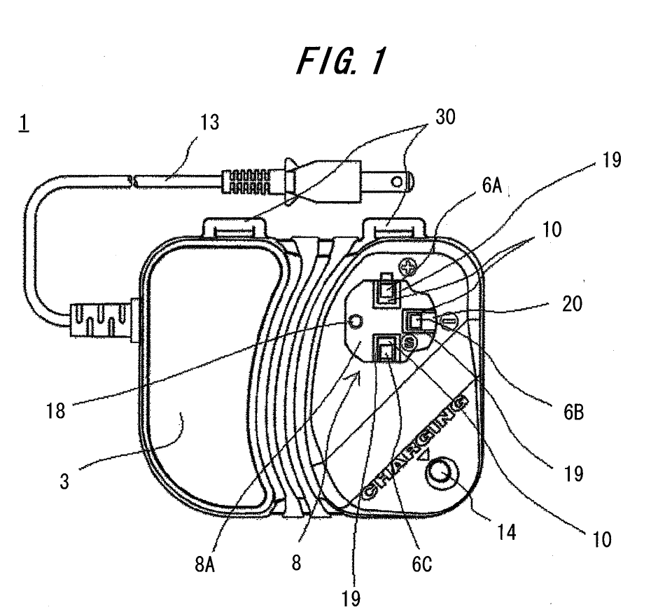

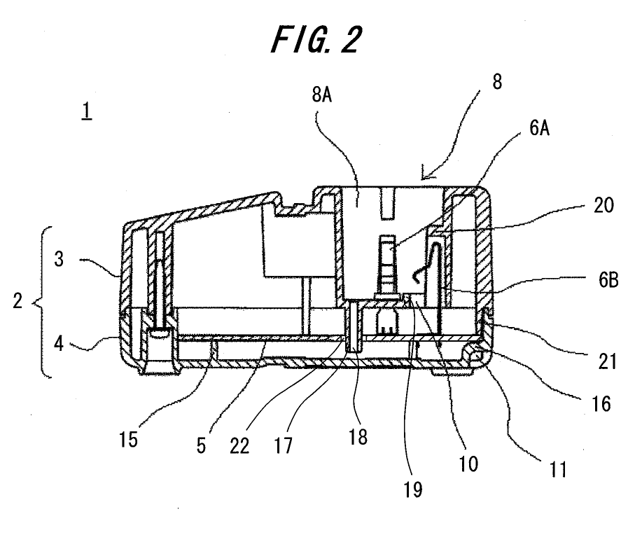

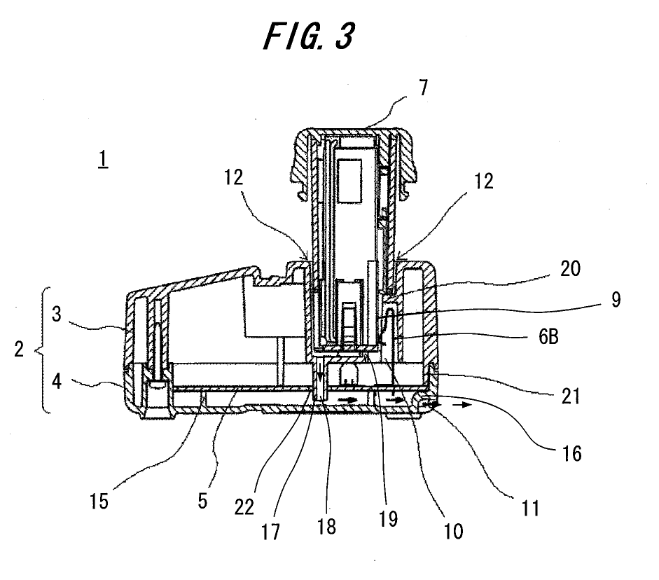

The battery charger 1 related to the embodiment of the present invention is described using FIGS. 1 to 3. FIG. 1 is a top view of the battery charger related to the embodiment of the present invention, FIG. 2 is a cross-sectional view of FIG. 1 and FIG. 3 is a view illustrating the situation when the battery pack is connected to the battery charger in FIG. 2.

The battery charger 1 is mainly configured of the battery connection portion 8 connecting to the battery pack 7, the top case 3 and the bottom case 4 to configure the body case 2, and the circuit substrate 5 mounted with a charging circuit to charge the battery pack 7. Electricity is supplied via the charging circuit from a power cord 13 to the charging terminal 6 described afterward to charge the battery pack 7 by contacting the charging terminal 6 with the charge and discharge terminal 9 of the battery pack 7 connected to the battery connection portion 8.

As described in more detail, as shown in FIG. 1 the battery charger 1 has a power cord 13, to which electricity is supplied from a commercial power source and the battery connection portion 8 for connecting to the battery pack 7. As shown in FIGS. 2 and 3, the plugging portion 8A of plugging the plugging-type battery pack 7 is formed on the battery connection portion 8. On the bottom of the plugging portion 8A, the charging terminal 6 composed of a positive electrode terminal 6A and a negative electrode terminal 6B in order to supply electricity supplied from the power cord 13 to the battery pack 7 connected and a signal terminal 6C (see FIG. 1), to which information on the battery pack such as temperature information and the like from the battery pack 7 are exposed at the plugging portion 8A, via the terminal insertion holes 10, described afterward. The charge and discharge terminal 9 of the battery pack 7 is connected to the corresponding terminal 6 to charge the battery back 7.

As shown in FIG. 1, a display portion 14 composed of, for example, a light emitting diode is also arranged in the battery charger 1 in order to display the charging state of the battery pack 7. For example, in the display portion 14, the light emitting diode turns on a light when charging the battery pack 7, and makes a light blink when terminating charging. This allows a user to understand the charging state of the battery pack 7. In the battery charger 1, a display component is not limited to the light emitting diode and the like, but a sound such as buzzer sound, voice and the like may be used to inform the charging state.

The battery charger 1 also has a hook portion 30 on the side in order to pass a belt and the like there through. The belt is passed through the hook portion 30 to suspend from a shoulder, allowing carry, or fixation to a wall, floor surface and the like, of the battery charger 1.

The inside of the battery charger 1 is next described using FIGS. 2 and 3. The battery charger 1 is divided into two; the top case 3 forming the battery connection portion 8 and the bottom case 4 accommodating the circuit substrate 5, thus configuring the body case 2 with the top case 3 and the bottom case 4.

The bottom case 4 accommodates the circuit substrate 5 mounted with electronic components comprising the charging circuit. The charging terminal 6 and the signal terminal 6C connected to the charge and discharge terminal 9 of the battery pack 7 is directly connected to the circuit substrate 5. One or a plurality of ribs 15 protruded from the bottom case 4 to the circuit board 5 are also provided. The circuit board 5 is supported by one or a plurality of the ribs 15 at the bottom surface and arranged in the bottom case 4. Furthermore, a receiver portion 16 is arranged at the inner side of the bottom case 4 to support the circuit substrate 5 on the bottom surface similarly as the rib 15. Also, a drain outlet 11 described afterward to communicate between inside and outside of the bottom case 4 is arranged on the bottom case 4.

On the other hand, the battery connection portion 8, in other words, the plugging portion 8A is integrally formed with the top case 3. Each of the terminal insertion holes 10 corresponding to the charging terminal 6 and the signal terminal 6C, which is connected to the circuit substrate 5 is formed at the bottom of the plugging portion 8A in order to expose both terminals to the plugging portion 8A. A protruded portion 17 protruded from the bottom of the plugging portion 8A towards the bottom case 4, is integrally formed with the plugging portion 8A at the bottom of the plugging portion 8A but at a different location from the terminal insertion holes 10. A through-hole 18 is arranged in the protruded portion 17, which is connected to the plugging portion 8A to become a guide portion. Furthermore, bulkheads 19 surrounding the circumference of the terminal insertion holes 10 and protruded upwards from the bottom of the plugging portion 8A (direction opposite to the bottom case 4) are arranged. Also protruded portions 20 protruded from the side of the plugging portion 8A to the inner direction of the plugging portion 8A (towards to the facing side) are also arranged within the plugging portion 8A and on the upper side of the charging terminal 6 and the signal terminal 6C of the battery charger 1. Furthermore, an end portion 21 is arranged at the location being part of the side of the top case 3 and facing the receiver portion 16 in the bottom case 4. The circuit substrate 5 is pinched and retained between the end portion 21 and the receiver portion 16 in the bottom case 4. An insertion hole 22 for inserting the protruded portion 17 integrally arranged with the top case 3 is formed on the circuit substrate 5.

Next, the relationship of this protruded portion 17 with the insertion hole 22 is described in detail using FIGS. 1 to 3.

As shown in FIG. 2, when the battery pack is not connected, the plugging portion 8A is open to the outside so that rain water can directly enter into the plugging portion 8A. As shown in FIG. 3, when the battery pack 7 is connected, rain water can also enter into the plugging portion 8A through the gap 12 between the outer surface of the battery pack 7 and the inner surface of the plugging portion 8A. However, the battery charger 1 related to the embodiment of the present invention is arranged with the protruded portion 17 with the through-hole 18 formed as a guide portion at the bottom of the plugging portion 8A so that rain water entered into the plugging portion 8A can be drained through the drain outlet 11 on the bottom case 4 without contacting with the circuit substrate 5. As described in more detail, the protruded portion 17 protruded towards the bottom case 4 and having the through-hole 18 along the protruding direction is arranged at the bottom of the plugging portion 8A. Then, the through-hole 18 is communicated with the plugging portion 8A and the lower side of the circuit substrate 5 in the bottom case 4. The insertion hole 22, into which this protruded portion 17 is inserted is arranged on the circuit substrate 5. Furthermore, the end of the protruded portion 17 is located at the same position as the bottom surface of the circuit substrate 5 or at the position protruded from the bottom surface of the circuit substrate 5 towards the bottom case 4 when inserting into the insertion hole 22 of the circuit substrate 5. Consequently, rain water entered into the plugging portion 8A to reach to its bottom flows downward through the through-hole 18 of the protruded portion 17 to the circuit substrate 5 (direction to the bottom case 4), draining from the drain outlet 11 of the bottom case 4 to the outside of the battery charger 1 as shown with an arrow in FIG. 3, thus enabling to reliably waterproof the circuit substrate 5 with a simple configuration.

The through-hole 18 of the protruded portion 17 is also connected to the plugging portion 8A so that rain water reached to the bottom of the plugging portion 8A flows out by itself along the through-hole 18 of the protruded portion 17. A tight waterproof structure of the battery charger 1 can be herewith simply configured without installing special members and with low cost. The end of the protruded portion 17 is also protruded to the same surface as the bottom surface of the circuit substrate 5 or downwards from its bottom surface. The battery charger 1 related to the present invention can thus waterproof the circuit substrate 5 more reliably. Furthermore, the protruded portion 17 is integrally formed with the top case 3 so that the circuit substrate 5 can be waterproofed at low cost without using separate components.

Also, the bulkheads 19 are arranged at the bottom of the plugging portion 8A so as to surround the terminal insertion holes 10, so that rain water reached to the bottom of the plugging portion 8A is blocked by the bulkheads 19, thus enabling to prevent it from flowing from the terminal insertion holes 10, onto the circuit substrate 5. Thereby rain water can be drained from the through-hole 18 of the protruded portion 17, making the circuit substrate 5 more reliably waterproof. Also, when the battery pack 7 is inserted into the plugging portion 8A, the battery pack 7 also contacts the bulkheads 19 and the protruded portions 20, thereby aligning accurately. The charge and discharge terminal 9 of the battery pack 7 can be thus accurately connected to the charging terminal 6 and the signal terminal 6C of the battery charger 1 and furthermore intrusion of rain water from the terminal insertion holes 10, can be prevented.

Moreover, the battery charger 1 related to the present invention also has the drain outlet 11 on the bottom case 4 so that rain water entered into the bottom case 4 is timely drained through the drain outlet 11 to the outside. Accumulation of rain water in the battery charger 1 and flooding of the electronic components mounted on the circuit substrate 5 can thus be prevented.

Furthermore, the battery charger 1 can be configured such that the bottom surface of the circuit substrate 5 abuts against the rib 15 so that the circuit substrate 5 is accommodated in the bottom case 4, and such that the receiver portion 16 provided on the bottom case 4 and subsequently the top case 3 is fit in as shown in FIG. 2. On this occasion, as well as the protruded portion 17 arranged on the plugging portion 8A entering into the insertion hole 22 of the circuit substrate 5, the circuit substrate 5 is sandwiched between the end portion 21 of the top case 3 and the receiver portion 16 of the bottom case 4 so that the circuit substrate 5 can be securely fixed and retained in the inside of the body case 2 (inside of the bottom case 4). Therefore, the circuit substrate 5 can be fixed to the bottom case 4 without using different components such as screws and the like, so that the battery charger 1 can be easily assembled and the number of components can be reduced to lower cost.

Additionally, the insertion hole 22 is arranged on the circuit substrate 5 so that configuration of the circuit substrate 5 is not restricted by the protruded portion 17. Therefore, the battery charger 1 related to the present invention does not require installation of different components such as a lead wire and the like of connecting the circuit substrate 5 to the charging terminal 6 and the signal terminal 6C so that it is economical. Furthermore, both the charging terminal 6 and the signal terminal 6C can be directly mounted on the circuit substrate 5, thus enabling miniaturization.

As described above, according to the battery charger 1 related to the embodiment of the present invention, the protruded portion 17 protruded into the inside of the body case 2 and having the through-hole 18 along the protruded direction is arranged on the battery connection portion 8, in other words, on the plugging portion 8A and the protruded portion 17 is inserted into the insertion hole 22 arranged on the circuit substrate 5 so that the circuit substrate 5 can be reliably waterproofed without increasing the size of the circuit substrate 5. Therefore, poor charging of the battery and malfunction of the battery charger caused by wetting the circuit substrate 5 and failure of the charging circuit caused by corrosion of electronic components can be prevented. The through-hole 18 of the protruded portion 17 is also connected to the plugging portion 8A of the battery connection portion 8 at the bottom so that rain water reached to the bottom of the plugging portion 8A can be drained by itself to the outside of the battery charger 1 without the need for arranging special members. Furthermore, the bulkheads 19 surrounding the terminal insertion holes 10, are arranged at the bottom of the plugging portion 8A so that the rain water leak from the terminal insertion holes 10, can be prevented to more reliably waterproof the circuit substrate 5.

Furthermore, the battery pack 7 is aligned by abutting the upper end of the bulkheads 19 against the battery pack 7 so that the battery pack 7 can be reliably charged while keeping the circuit substrate 5 waterproofed. The protruded portion 17 of the battery connection portion 8 is also integrally formed with the top case 3 so that the battery charger 1 can be constructed with a simple configuration without the need for arranging separate members.

Also, the configuration is made such that the rib 15 of supporting the circuit substrate 5 is also arranged on the bottom case 4 and the circuit substrate 5 is sandwiched between the top case 3 and the bottom case 4 when the top case 3 is combined with the bottom case 4 while accommodating the circuit substrate 5 in the bottom case 4, so that arrangement of separate members for aligning and holding the circuit substrate 5 is not required, thus giving inexpensive and simple configuration.

In the present embodiment, the protruded portion 17 has the through-hole 18 as a guide portion and is cylindrical, but various shapes can be formed so far as rain water entered into the plugging portion 8A does not wet the circuit substrate 5. For example, the protruded portion 17 may be a cylinder having a C-shaped cross-section, in which a part of the side surface thereof has an opening. In this case, the protruded portion 17 is preferably formed such that the open portion is directed to the direction avoiding the electronic components on the circuit substrate.

In the embodiment described above, the through-hole 18 of the protruded portion 17 is also described as guiding rain water to the bottom case 4 and draining rain water from the drain outlet 11 provided on the bottom case 4, but the through-hole 18 of the protruded portion 17 may be integrally arranged with the drain outlet 11. In other words, the protruded portion 17 may be configured to pass through the bottom case 4 in order to directly drain rain water from the through-hole 18 of the protruded portion 17 to the outside.

In the embodiment above, the plugging-type battery charger 1 has been described, but the present invention is not limited by this and for example, a slide-type battery charger and the like may be applicable.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

The present application claims the priority based on Japanese Patent Application No. 2007-248250 filed on Sep. 25, 2007, of which the contents are herein incorporated by its entirety.

What is claimed is:

1. A battery charger for charging a battery pack, comprising;
a circuit substrate having a circuit provided with a charging terminal for connecting to the battery pack and having an insertion hole formed thereon, and
a body case having a battery connection portion for connecting to a terminal of the battery pack and a drain outlet configured to drain water intruded into inside of the body case, the body case accommodating the circuit substrate in a space between the battery connection portion and the drain outlet, having a protruded portion protruding to pass through the insertion hole from the battery connection portion and having a guide portion formed on the protruded portion and communicated with the battery connection portion extending towards the protruding direction of the protruded portion.

2. The battery charger according to claim 1, wherein the body case comprises a first casing having the battery connection portion and a second casing having the drain outlet.

3. The battery charger according to claim 1, wherein the guide portion is a through-hole for passing the protruded portion in the protruding direction.

4. The battery charger according to claim 1, wherein the battery connection portion has a retention portion for retaining the battery pack and the protruded portion is protruded from the bottom surface of the retention portion.

5. The battery charger according to claim 4, wherein the retention portion has terminal insertion holes for inserting the charging terminal at the bottom and is arranged with bulkheads around the terminal insertion holes, protruding in the direction facing the battery pack.

6. The battery charger according to claim 5, wherein the retention portion has an insertion portion for inserting the battery pack and the end of the bulkheads contact the battery pack when the battery pack is inserted into the insertion portion.

7. The battery charger according to claim 2, wherein the protruded portion is integrally configured with the first casing.

8. The battery charger according to claim 1, wherein the charging terminal is directly mounted on the circuit substrate and the circuit substrate is positioned on the lower side of the charging terminal.

9. The battery charger according to claim 2, wherein the second casing has a rib protruded into the inside of the body case, the circuit substrate abuts against the rib to be accommodated in the second casing, and the protruded portion is inserted into the insertion hole by sandwiching the circuit substrate between the first casing and the second casing.
